(19) United States
(12) Patent Application Publication
(10) Pub. No.: US 2007/0057208 A1
(43) Pub. Date: Mar. 15, 2007

(54) Method and device for monitoring a moving fabric web

(76) Inventors: Rolf Joss, Horgen (CH); Beat Emch, Eglisau (CH); Tim Palmer, Cambridgeshire (GB); Peter Brady, Cambridgeshire (GB)

Correspondence Address: BUCHANAN, INGERSOLL & ROONEY PC, POST OFFICE BOX 1404, ALEXANDRIA, VA, 22313-1404, US

(21) Appl. No.: 10/564,480

(22) PCT Filed: Jul. 8, 2004
(86) PCT No.: PCT/CH04/00432

§ 371 Date: Jun. 20, 2006

(30) Foreign Application Priority Data
Jul. 14, 2003 (CH) 123/03

(51) Int. Cl. G01N 21/86; G01V 8/00

(52) U.S. Cl. 250/559.19

(57) ABSTRACT

The invention relates to a method and a device for monitoring a moving fabric web (1), at least a part (7) of the width of the fabric web being detected. In order to maintain the geometrical ratios between the individual elements from which the fabric web is constructed as far as possible in the image of the fabric web also, an image of the fabric web is to be produced on the one hand and on the other hand the movement of the fabric web is to be detected in the same part of the fabric web.

The invention relates to a method and a device for monitoring a moving fabric web, at least a part of the width of the fabric web being detected.

A device is known from DE 101 23 870 for the automatic monitoring of in particular textile fabrics or woven fabric webs, this device being arranged directly on the production machine of the fabric or woven fabric web. In the case of this device, several very small sensors are arranged having direct contact with the fabric. The device is attached to the production machine via a vibration-damping suspension, so that a transfer of the machine movement only takes place via the textile fabric.

Although in the case of this device the woven fabric web or the textile fabric is in direct contact with the sensor or its covering glass, faults can occur in imaging of the fabric by the sensor, for example displacements of image sections in relation to one another, which result in the image of the fabric no longer corresponding to the original. In these circumstances it is then difficult to detect faults in the fabric with certainty, since warp or weft threads, for example, in a woven fabric are no longer equidistant in the image.

The invention as characterized in the claims thus achieves the object of producing a method and a device for monitoring moving fabric webs with at least one sensor strip, which maintains the geometrical ratios between the individual elements from which the fabric web is constructed as far as possible in the image of the fabric web also.

This is achieved in that on the one hand, an image of at least a part of the fabric web is produced, and on the other hand the movement of the fabric web is detected in the same part of the fabric web. From the image of the fabric web a first signal is generated, and in the same part of the fabric web the movement of the fabric web is detected and a second signal generated. The first and second signal are offset in a suitable manner in order to maintain in the image also the geometrical ratios existing in the fabric web between the individual elements that together produce the image.

In a device suitable for this, a sensor strip for scanning the fabric web seen in the direction of the width of the fabric web can be arranged at an acute angle, so that information regarding a characteristic connected with the movement of the fabric web can be derived from the signal of the same sensor strip. An image of the fabric web in the relevant part is also to be produced from the same signal, this image being built up line-wise or section-wise. However, the sensor strips can also be oriented perpendicular to the movement of the fabric web and at least one further sensor for detecting a characteristic connected with the movement of the fabric web can be arranged in the area of this part of the fabric web. A further sensor of this kind is preferably an optical sensor with one or more scanning lines.

This method and this device are used in the most common application for detecting faults in the fabric web, such as differences in the structure, colour or from patterns on the fabric web, signalling these or triggering further actions such as stopping of the fabric web, for example. A particularly important characteristic connected with the movement of the fabric web is its momentary speed, which then applies precisely when an image of a section of the fabric web is recorded or produced.

The advantages achieved by the invention are to be seen in particular in the fact that, from the signals of the sensor strip and the possibly additional signals that a further sensor emits, the geometrical ratios between individual elements of the fabric web, such as between adjacent warp and weft threads in a woven fabric, for example, can be maintained even in the image of the woven fabric produced from signals of the sensor strip. It is easier and also more reliable for example to correct these geometrical ratios starting out from a momentary speed instead of from an averaged speed. The further sensor can also only detect distances, in that it emits a pulse after fixedly predetermined distances covered, for example, or if supplied externally with clock pulses it outputs the distances covered per clock interval by the fabric web. With the distance signal and with the signal from the sensor strip, graphic patterns or structures of the fabric web can be reproduced correctly and without distortion in the image due to suitable offsetting of both signals, so that interruptions of these patterns or of the structure can also be detected correctly in the monitoring.

The invention is explained in greater detail below with reference to an example and to the enclosed figures.

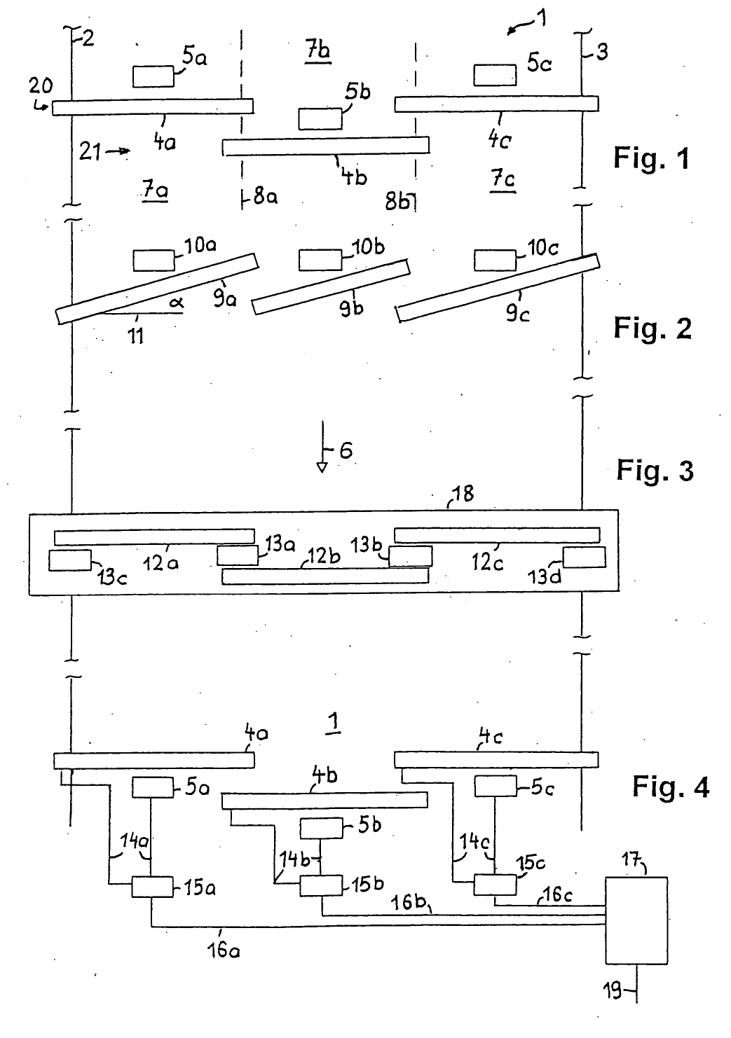

FIG. 1 shows a first diagrammatic representation of an arrangement according to the invention of sensor strips and further sensors ahead of a fabric web,

FIGS. 2, 3, 5 and 6 each show a further arrangement of sensor strips,

FIG. 4 shows an arrangement according to FIG. 1 with further elements,

FIG. 7 shows a distance—time diagram for a fabric web,

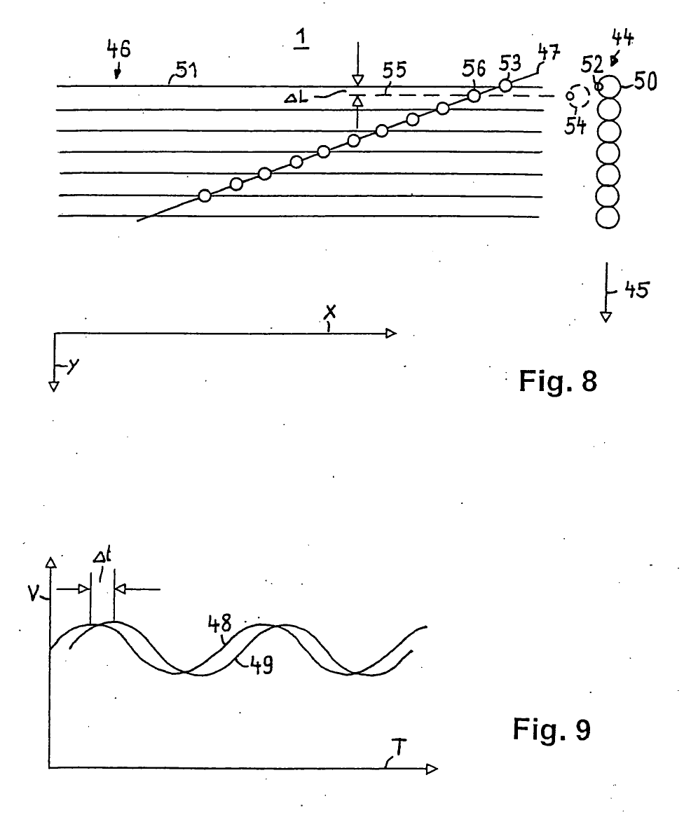

FIG. 8 shows a diagrammatic representation of the geometrical ratios on scanning of a fabric web and

FIG. 9 shows a signal such as is possibly generated by sensor strips according to FIG. 2.

FIG. 1 shows ahead of a fabric web 1, the edges of which are indicated by lines 2 and 3, sensor strips 4a, 4b, 4c, which are formed identical to one another, as well as further sensors 5a, 5b, 5c, which detect a characteristic of the fabric web that is connected with the movement of the fabric web 1. Such characteristics are for example the distance that the fabric web 1 covers, the momentary speed of the fabric web 1 in the direction in which it is moving, the acceleration in the event of changes of speed, etc. Each sensor strip 4 and each further sensor 5 are arranged so that they traverse a part of the fabric web 1 when this moves in the direction of an arrow 6 (FIG. 3). Such parts 7a, 7b, 7c of the fabric web 1 are delimited in FIG. 1 by further lines 8a, 8b inside the fabric web 1. The sensor strips 4a and 4c and any further sensor strips present and not shown here form a first sensor line 20, while the sensor strip 4b, alone or together with possible further sensor strips not shown here, forms a second sensor line 21, which runs parallel to the first sensor line 20.

The sensor strips 4a and 4c from the first sensor line 20 and the sensor strip 4b from the adjacent second sensor line 21 partly overlap seen in the direction of movement of the fabric web.

FIG. 2 shows a further arrangement of sensor strips 9a, 9b, 9c and possible further sensors 10a, 10b, 10c, the sensor strips 9 being inclined by an angle α, which here for example is 15°, towards a line 11 that extends in the direction of the width of the fabric web 1, perpendicular to the direction of the arrow 6.

FIG. 3 shows an arrangement of sensor strips 12a, 12b, 12c according to FIG. 1, but with further sensors 13a and 13b, which can each be assigned to two sensor strips, as well as further sensors 13c and 13d, which are only assigned here to one sensor strip. The further sensors 13a and 13b are arranged in the edge areas of the sensor strips 12. It should be noted here that the arrangements shown with three sensor strips have been chosen arbitrarily and are only to be interpreted as examples. Naturally any number of sensor strips 12 can be arranged, the greater the width the more sensor strips, to detect the entire width of the fabric web 1. This applies to all arrangements shown in FIGS. 1 to 6. However, it is the case in particular for the arrangement according to FIG. 3 that two further sensors are assigned in each case to the sensor strips 12. For example, the further sensors 13a and 13b are assigned to the sensor strip 12b. Further sensors 13a and 13c are assigned to the sensor strip 12c. Further sensors 13b and 13d are assigned to the sensor strip 12c. The sensor strips 12 are arranged together with the further sensors in a housing 18, which also has suitable lighting for the fabric web 1 if no light source is integrated into the sensor strips.

FIG. 4 shows an arrangement of the sensor strips 4a-4c as already known from FIG. 1. In contrast to that, however, the further sensors 5a-5c are no longer connected upstream of the sensor strips 4, but downstream. This is measured against the direction of movement of the fabric web 1 as indicated by the arrow 6. Lines 14a, 14b and 14c connect the sensor strips 4 and the further sensors 5 to a processor 15a, 15b, 15c respectively, which are connected via lines 16a, 16b, 16c to an input/output device 17. Thus several sensor strips and several further sensors are assigned to a common input/output device 17. An output 19 on the input/output device 17 serves for example as a connection to a computer, such as a so-called PC, to which several devices according to the invention can be connected.

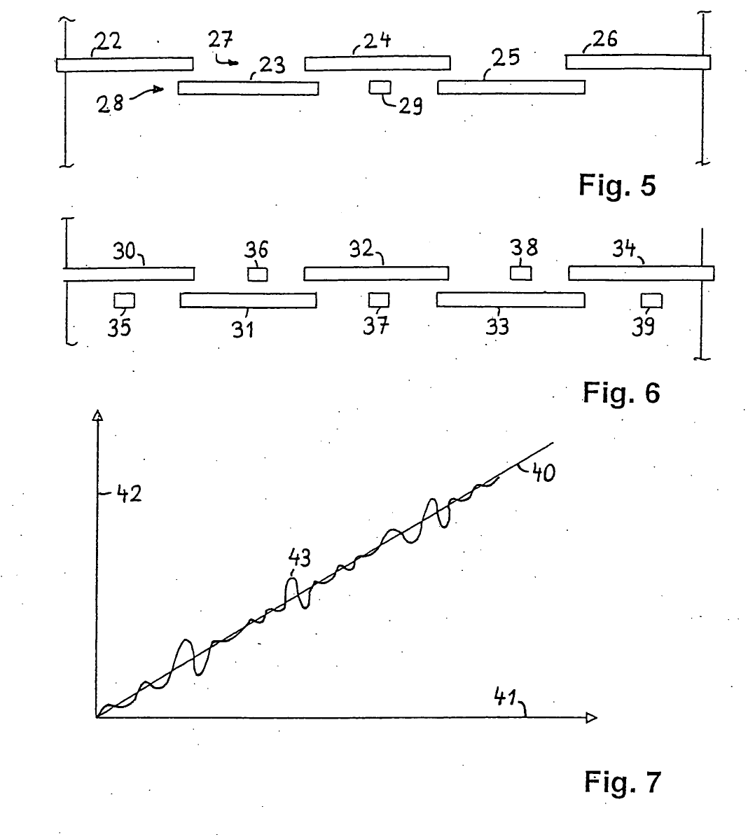

FIG. 5 shows an arrangement of five sensor strips 22, 23, 24, 25 and 26, the sensor strips 22, 24 and 26 forming a first sensor line 27 and the sensor strips 23 and 25 forming a second sensor line 28. A further sensor 29 is assigned here only to the sensor strip 24 and detects a part of the fabric web that is also detected by the sensor strip 24, the sensor strip 24 and the further sensor 29 not scanning the fabric web according to the same criteria or detecting the same features therein.

FIG. 6 shows a further arrangement with five sensor strips 30, 31, 32, 33 and 34 and five further sensors 35, 36, 37, 38 and 39. Here the further sensors are arranged respectively adjacent to the sensor strips for which they supply no movement indication. Thus the further sensors are connected seen in the direction of movement of the fabric web 1 alternately upstream and downstream of the assigned sensor strips. For example, the further sensor 35 is connected downstream of the relevant sensor strip 30, while the further sensor 36 is connected upstream of the relevant sensor strip 31, or vice-versa. This arrangement makes it possible to fit the sensor strips and the further sensors in a particularly space-saving arrangement.

FIG. 7 shows a distance-time diagram, for example for the fabric web 1, a line 40 indicating the distance covered per unit of time by the fabric web 1 with always ideal, uniform movement of the fabric web 1. Thus values for the distance covered can be entered along one axis 42 and values for the time along an axis 41. A curve 43 represents the distance actually covered by the fabric web at different times, which distance is produced by the uneven movement of the fabric web in the area of the sensor strips and further sensors.

FIG. 8 shows in a diagrammatic representation the ratios as they appear with the arrangement of an inclined sensor strip as shown in FIG. 2. 44 here denotes a section through a group of weft threads of a woven fabric that is moving in the direction of an arrow 45. Slewed by 90° in comparison with the section 44, the centre lines or axes of these weft threads are drawn in with horizontal lines 46, the warp threads or their influence on these centre lines or axes and thus the weaves being left out here to make the representation simpler. A sensor strip 47 is represented here only by those discrete elements that can detect picture elements from the fabric web. The sensor strip 47 here is an optical sensor with a single scanning line. A coordinate system characterizes further an X-axis corresponding to the width of the fabric web and a Y-axis corresponding to the direction of movement of the fabric web 1.

FIG. 9 shows a first signal 48 and a second signal 49 such as a sensor strip can emit when it detects a woven fabric. Both signals 48, 49 are recorded over a time axis T and next to an axis V, the axis V indicating the amplitude of the signal from the sensor strip, which is expressed for example by an electric voltage.

The mode of operation of the invention is as follows: While for example one sensor strip 4a (FIG. 4) scans the part 7a of the fabric web 1 and maps this onto picture elements and converts it into intensity values, or into grey scale and colour values, which are stored in the memory of the processor 15a, the further sensor 5a continuously emits a signal to the processor 15a, which represents for example the momentary movement of the part 7a of the fabric web 1 in the area of the sensor strip 4a. The further sensor 5a traverses a section inside the part 7a of the fabric web 1. This applies likewise to the further sensors 5b, 5c and the parts 7b, 7c of the fabric web 1. The processors 15 contain a program in the program memory that recognizes periodicities or projecting signal portions from the signal of the sensor strip and processes these together with the signal from the further sensor. The aim of this program is to form a clearly structured signal or a clear image from the signal of the sensor strip. The object should thus for example be achieved that in an image that can be composed from the picture elements in the data memory of a processor 15, in a textile fabric the geometrical relationships between the individual yarns or threads are preserved such that they correspond to those of the actual fabric. In the case of woven fabrics, the structure from the warp threads and the weft threads should thus be made clearly recognizable. Original distances or geometrical ratios between warp and weft threads of a woven fabric or between threads of a knit fabric should be reproduced in the image. Due to the further sensors arranged as closely as possible to and in the working area of the sensor strips on the fabric web 1, it is possible to detect even local movements that are different in the individual parts 7a-7c, such as e.g. distortion, and to compensate for them, i.e. to ensure that the effect of the distortion does not geometrically distort the image from the sensor strip. In particular, the further sensors 5, 10, 13, 29, 35-39 detect the movement of the fabric web 1 as shown for example in FIG. 7. From this it is recognized that the fabric web does not always cover identical distances per unit of time. Thus the images that the sensor strips 4, 9, 12 and 22-26 detect can even contain not always the same number of elements such as threads, weft threads, etc. If this image information is combined with the signal relating to the movement for example from the further sensor, a faithful image of the fabric web can be produced even if its movement is uneven.

If no further sensor is used and if a characteristic connected with the movement of the fabric web is to be detected by the sensor strip alone, then the latter must be inclined by an angle α, as shown in FIG. 2. The movement of the fabric web can be detected as shown with reference to FIGS. 8 and 9. As an example, we are assuming here that the fabric web has a three-dimensional structure such as applies to textile fabrics, and that it moves in the direction of an arrow 45. If we look at the movement of a single weft thread 50, which is also represented by its centre line or axis 51, then a curve is produced for example for the intensity of light that is reflected at this or absorbed by this, corresponding to a signal 48 (FIG. 9). The signal 48 is produced in particular by a point or a surface line 52 of the weft thread 50, which is also represented by the centre line 51, passing by a sensor element 53, the sensor element 53 being able to generate a picture element, meaning that in this picture element the intensity progresses corresponding to the signal 48. If a short time later the weft thread 50 reaches a place (shown here moved forward for greater clarity) in the direction of the arrow 45 as designated by 54, which corresponds to a position of the centre line corresponding to a dashed line 55, then an adjacent sensor element 56 detects this weft thread in its position 54, a signal 49 according to FIG. 9 being produced, which is delayed by a time Δt relative to the signal 48. However, since a distance ΔL between the sensor elements 53 and 56 or centre lines 51 and 55 is known, the momentary speed v of the fabric web 1 is found according to the formula v=ΔL/Δt. However, it is also possible to calculate from this even the acceleration, for example, as another characteristic that is connected with the movement of the fabric web.

The movement of the fabric web 1 or a characteristic connected with the movement of the fabric web can also be ascertained from the overlapping sensor strips, as shown for example in FIG. 3. In the overlapping area of the sensor strips 12a and 12b, which is located before and after the further sensor 13a that is drawn in here but not required in this case, the same parts of the fabric web 1 are detected and thus comparable signals produced, which occur, however, with a delay that corresponds to the distance between the two sensor strips 12a and 12b divided by the speed of the fabric web 1 in this area. Since the distance is known and the delay can be determined from both signals, the speed can be calculated from this.

Sensors known by the designation “contact type image sensor”, for example, such as are installed in a flatbed scanner or a fax machine for scanning a piece of paper supplied, can be used as sensor strips 7, 9, 12. In this case the sensors can contact the fabric web directly, or they are covered by a cover plate for example of glass, which is touched by the fabric web. A small air gap can also separate the fabric web and the sensor from one another. It is possible also to use surface cameras or line cameras instead of the said contact sensors or sensor strips, which cameras then scan a rather larger area of the fabric web seen in the direction of the arrow 6. The further sensor 5, 10, 13 can be a sensor such as is known for example by the name “CMOS Active Pixel Image Sensor” supplied by National Semiconductor. Even a further sensor such as supplied by Agilent Technologies under the name ADNS-2051 Optical Mouse Sensor can be used.

1. Method for monitoring a moving fabric web, at least a part of the width of the fabric web being detected, wherein on the one hand an image of the fabric web is produced and on the other hand the movement of the fabric web is detected in the same part of the fabric web.

2. Device for executing the method according to claim 1, wherein a sensor strip is arranged inclined at an angle to the fabric web, and thus on the one hand an image of the fabric web is produced and on the other hand a characteristic connected with the movement of the fabric web is detected in the area of this part of the fabric web.

3. Device for executing the method according to claim 1, wherein apart from a sensor strip, with which an image of the fabric web is produced, at least one further sensor for detecting a characteristic connected with the movement of the fabric web is arranged in the area of this part of the fabric web.

4. Device according to claim 3, wherein seen across the width of the fabric web, several sensor strips are arranged each with a further sensor, the sensor strips being arranged behind one another in the direction of the width of the fabric web and forming a sensor line.

5. Device according to claim 4, wherein at least two substantially parallel sensor lines are arranged relative to the fabric web.

6. Device according to claim 4, wherein a sensor strip from a first sensor line and a sensor strip from an adjacent second sensor line partly overlap seen in the direction of movement of the fabric web.

7. Device according to claim 6, wherein a sensor strip from the adjacent sensor line is provided as a further sensor, a characteristic connected with the movement of the fabric web being acquired from the signals of the two overlapping sensor strips.

8. Device according to claim 6, wherein a further sensor is arranged in the area of overlap of the two sensor strips.

9. Device according to claim 5, characterized in that wherein in each sensor line a further sensor is arranged next to a sensor strip seen in the direction of the width of the fabric web.

10. Device according to claim 3, wherein the further sensor is an optical sensor with several scanning lines.

11. Device according to claim 3, wherein the sensor strip is an optical sensor with one scanning line.

12. Device according to claim 3, wherein the sensor strip is a so-called contact image sensor such as is used in a flatbed scanner.

13. Device according to claim 2, wherein a processor, which is connected to an input/output device, is assigned to the sensor strip.

14. Device according to claim 11, wherein a common input/output device is assigned to several sensor strips and several further sensors.

15. Method according to claim 1, wherein a first signal is generated from the image of the fabric web and in the same part of the fabric web the movement of the fabric web is detected and a second signal is generated, and the first and the second signal are offset in a suitable manner, in order to produce original geometrical ratios, such as graphic patterns and structures of the fabric web, in the image also.
